(19) United States
(12) Patent Application Publication
(10) Pub. No.: US 2026/0249545 A1
(43) Pub. Date: Aug. 27, 2026

(54) MAGNETIC TEXTURED SUBSTRATE OF A 3D PRINTING SYSTEM

(71) Applicant: NISSAN NORTH AMERICA, INC., Franklin, TN (US)

(72) Inventors: Federico VENTURI, Novi, MI (US); Nanzhu ZHAO, Sugar Land, TX (US)

(21) Appl. No.: 19/060,465

(22) Filed: Feb. 21, 2025

(51) Int. Cl. B29C 64/124; B29C 64/245; B29C 64/255; B33Y 30/00

(52) U.S. Cl. CPC B29C 64/124; B29C 64/245; B29C 64/255; B33Y 30/00

(57) ABSTRACT

A 3D printing system includes a tank including an optically transparent window through which light is configured to pass. A polymer layer is disposed on the optically transparent window. The polymer layer is optically transparent such that light is configured to pass therethrough. A plurality of pillars extend upwardly from an upper surface of the polymer layer to define a textured substrate. Each of the plurality of pillars includes a magnetic material. A layer of an inert material is disposed on the polymer layer. A liquid photopolymer resin is disposed on the layer of the inert material.

### BACKGROUND

### Field of the Invention

The present invention generally relates to a system and method of 3D printing. More specifically, the present invention relates to a magnetic textured substrate of a 3D printing system.

### Background Information

3D (three-dimensional) printing is the construction of a three-dimensional object from a digital file, such as a CAD model or a digital 3D model. A conventional additive manufacturing process creates the object by successively adding layers one at a time until the object is complete. One type of additive manufacturing process is vat polymerization, which includes stereolithography (SLA) and digital light processing (DLP) processes.

As shown in step S1 of FIG. 1, DLP 3D printing includes a tank, or vat, 10 having a transparent projection window 12. The vat 10 contains a liquid polymer resin 14. A build platform 16, on which an object is to be printed, is lowered into the resin 14.

A light projection system 18, such as a laser, projector or LED/LCD panel, emits a light 20, such as ultraviolet light, through the transparent projection window 12 in the vat 10, as shown in Step S2 of FIG. 1. The emitted light 20 causes a reaction within the resin 14 in which the molecules bond together, or cure, to form a first layer of a solid object 22 on the build platform 16. The entire first layer is cured simultaneously. The build platform 16 is moved in a direction away from the transparent projection window 12 to form a second layer on the first layer. Layers are formed, one layer at a time, until the object is printed.

During the printing process, the polymerized resin can adhere to the transparent projection window 12 of the vat 10, which can interfere with forming additional layers on the build platform 16. Additionally, the gap between the build platform 16 and the transparent window 12, or between the formed solid object 22 on the build platform 16 and the transparent window 12 for subsequent layers, is small (e.g., a distance substantially equal to a thickness of one formed layer on the build platform). As shown in step S3 of FIG. 1, the build platform 16 is removed from the vat 10. Any polymerized resin adhered to the transparent window 12 of the vat 10 can be removed, and additional liquid polymer resin 14 can be added to the vat 10.

As shown in step S4 of FIG. 1, the build platform 16 is lowered into the liquid polymer resin 14 in the vat 10 until the appropriate distance between the printed object 22 and the transparent window 12 is obtained. The separation step of the build platform 16 from the vat 10 in step S3 and repositioning the build platform 16 in the vat 10 in step S4 are time consuming steps that slow down the DLP 3D printing process. Removing any resin adhered to the transparent window 12 further slows down the printing process.

A conventional 3D printing system used in the DLP 3D printing process of FIG. 1 is shown in FIG. 2. The light projection system 18 emits light, such as UV (ultraviolet) light, corresponding to a single image of the layer to be formed on the build platform 16. The emitted light 20 passes through a projection lens 24 to adjust the resolution of the emitted light 20. The projection lens 24 is selected based on the desired focal depth, such as 30 or 100 micrometers. The projected light 26 is transmitted to a mirror 28. The reflected light 30 is transmitted into the vat 10 through a transparent window 12 (FIG. 1) thereof. The reflected light 30 cures the resin in the vat 10 to form a first layer of the printed object 22. A robotic arm 32 moves the build platform 16 such that successive layers can be formed to construct the printed object 22.

### SUMMARY

A need exists for a 3D printing system in which adhesion between the printed object and the window is substantially prevented. A need also exists for a 3D printing process in which resin flows in a timely manner toward a gap between a printed object and a window to form a successive resin layer to facilitate continuous photopolymerization. A further need exists for a 3D printing process facilitating resin flow.

In view of the state of the known technology, one aspect of the present disclosure is to provide a 3D printing system including a tank including an optically transparent window through which light is configured to pass. A polymer layer is disposed on the optically transparent window. The polymer layer is optically transparent such that light is configured to pass therethrough. A plurality of pillars extend upwardly from an upper surface of the polymer layer to define a textured substrate. Each of the plurality of pillars includes a magnetic material. A layer of an inert material is disposed on the polymer layer. A liquid photopolymer resin is disposed on the layer of the inert material.

Another aspect of the present disclosure is to provide a 3D printing system including a tank including an optically transparent window through which light is configured to pass. A polymer layer is disposed on the optically transparent window. The polymer layer is optically transparent such that light is configured to pass therethrough. A plurality of pillars extend upwardly from an upper surface of the polymer layer to define a textured substrate. Each of the plurality of pillars includes a magnetic material. A layer of an inert material is disposed on the polymer layer. A liquid photopolymer resin is disposed on the layer of the inert material. A first end of each of the plurality of pillars is disposed in the polymer layer, and a second end of each of the plurality of pillars is disposed above the polymer layer. An upper surface of the inert material is spaced above the second end of each of the plurality of pillars.

Also other objects, features, aspects and advantages of a magnetic textured substrate of a 3D printing system will become apparent to those skilled in the art from the following detailed description, which, taken in conjunction with the annexed drawings, discloses exemplary embodiments of the magnetic textured substrate of a 3D printing system.

### BRIEF DESCRIPTION OF THE DRAWINGS

Referring now to the attached drawings which form a part of this original disclosure:

FIG. 1 is a schematic representation of a conventional 3D printing system and method;

FIG. 2 is a perspective view of a conventional 3D printing system of FIG. 1;

FIG. 3 is a side elevational view of a tank of a 3D printing system prior to forming a textured substrate in accordance with an exemplary embodiment;

FIG. 4 is a side elevational view of the tank of FIG. 3 in which a magnetic field is applied to the tank;

FIG. 5 is a side elevational view of the 3D printing system of FIG. 4 in which a liquid polymer is added to the tank during application of the magnetic field;

FIG. 6 is a side elevational view of the tank of FIG. 5 in which the textured substrate is formed;

FIG. 7 is a side elevational view of the tank of FIG. 6 in which a layer of an inert material and a liquid photopolymer resin are disposed on the textured substrate;

FIG. 8 is a side elevational view of the tank of a FIG. 7 in which a magnetic field is applied to the tank to facilitate resin flow;

FIG. 9 is a graph of shear stress vs. viscosity;

FIG. 10 is a first graphical illustration of resin flow;

FIG. 11 is a second graphical illustration of resin flow;

FIG. 12 is a side elevational view of a tank in accordance with another exemplary embodiment in which a plurality of projections are disposed between adjacent magnetic pillars;

FIG. 13 is a side elevational view of the tank of FIG. 7 in which the magnetic pillars have varying heights;

FIG. 14 is a side elevational view of the tank of FIG. 7 in which the magnetic pillars are angularly disposed relative to an upper surface of the polymer layer;

FIG. 15 is a side elevational view of the tank of FIG. 7 in which the magnetic pillars have a tapered upper end; and

FIG. 16 is side elevational view of the tank of FIG. 7 in which the magnetic pillars are non-symmetric.

### DETAILED DESCRIPTION OF EXEMPLARY EMBODIMENTS

Selected exemplary embodiments will now be explained with reference to the drawings. It will be apparent to those skilled in the art from this disclosure that the following descriptions of the exemplary embodiments are provided for illustration only and not for the purpose of limiting the invention as defined by the appended claims and their equivalents.

Referring initially to FIG. 3-11, a 3D printing system 110 in accordance with an exemplary embodiment includes a tank 112, a textured substrate 114, a layer of an inert material 116, and a liquid photopolymer resin 118. The 3D printing system 110 further includes a rigid base 120 on which an object 122 is configured to be printed. A control arm 124 is connected to the rigid base 120 to control movement of the rigid base 120.

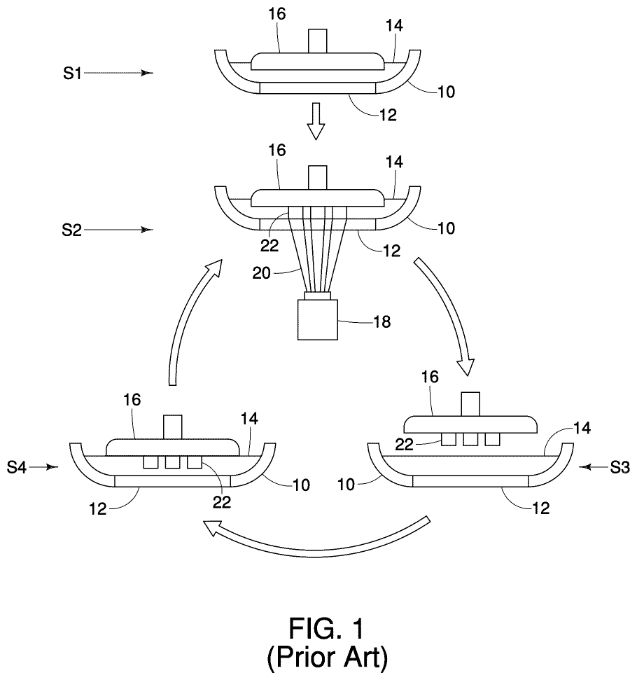

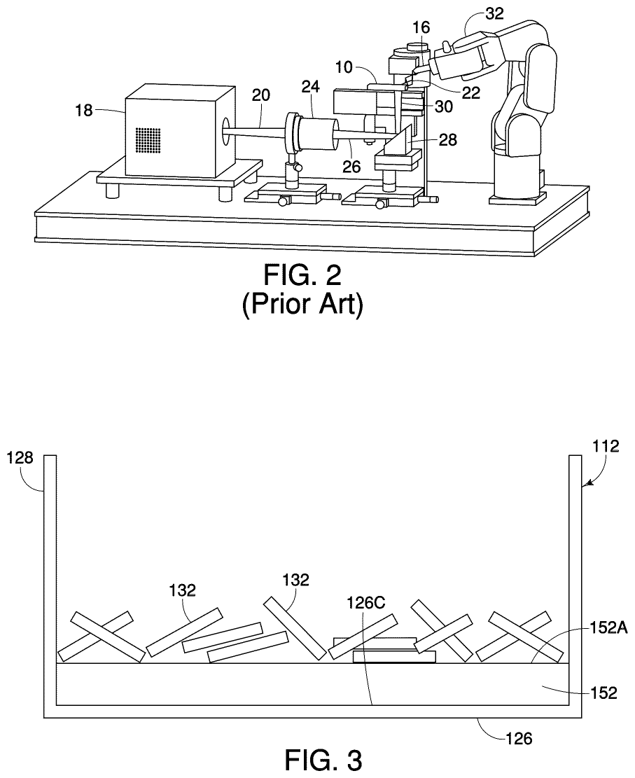

The rigid base 120 has a print surface 120A on which the object 122 is configured to be printed, as shown in FIG. 7. The control arm 124 is connected to the rigid base 120 to move the rigid base 120 relative to the tank 112. A light source (18, FIG. 1) is configured to emit light (20, FIG. 1) to the tank 112 to form the printed object 122 on the rigid base 120.

The tank 112 contains the liquid photopolymer resin 118, as shown in FIG. 7. The tank 112 can be any suitable shape to hold the liquid polymer resin 118 therein, such as rectangular or circular. The tank 112 has a base 126 and a side wall 128 extending upwardly from the base 126. The base 126 is preferably transparent such that the light emitted from the light source can pass through the base 126. The entirety of the base 126 can be transparent, or a portion of the base 126 can be transparent. The transparent portion of the base 126 constitutes an optically transparent window 126A through which the emitted light can pass. In other words, the tank 112 includes an optically transparent window 126A through which light is configured to pass. The base 126 is made of any suitable material, such as glass. As shown in FIG. 3-7, an optically transparent member 152 is disposed on the inner surface 126C of the base 126. The optically transparent member 152 is made of any suitable material, such as glass. Alternatively, the optically transparent member 152 can be integrally formed with the base 126 as a one-piece member, such that the optically transparent member 152 and the base 126 define the optically transparent window 126A.

The rigid base, or build platform, build plate or print bed, 120 provides the surface 120A on which the object 122 is printed. The print surface 120A is preferably a planar surface, as shown in FIG. 7. The rigid base 120 can be made of any suitable material, such as plastic, such as polyactic acid (PLA), or glass.

The control arm 124 is connected to the rigid base 120 to control movement and positioning of the rigid base 120 during the printing process. The control arm 124 is connected to the rigid base 120 to move the rigid base 120 relative to the tank 112. The control arm 124 preferably has six degrees of freedom, such that the rigid base 120 can move through a curvilinear path to more accurately print the object 122. The control arm 124 is preferably a robotic arm having six degrees of freedom. The six degrees of freedom are movements along the three axes (i.e., the X, Y and Z axes), and rotation about each of the three axes (i.e., pitch, roll and yaw). Providing the control arm 124 with multiple degrees of freedom, such as six degrees of freedom, allows the control arm 124 to move the rigid base 120 through a curvilinear path, including moving the rigid base 124 to a plurality of positions, thereby allowing a more accurate object 122 to be printed.

The liquid polymer resin 118 is selectively cured by light-activated polymerization, such as by photopolymerization, which preferably uses visible or UV light, although light having any suitable wavelength can be used, to form in situ cross-linked polymer structures. The liquid polymer resin 118 preferably includes monomer and oligomer molecules that are converted to solid polymers during photopolymerization when the light emitted by the light source is guided through the transparent portion, or the optically transparent window 126A, of the base 126 of the tank 112.

The light source emits light to cure the liquid polymer resin 118 in the tank 112, as shown in FIG. 7. The light source preferably emits UV light having a wavelength between approximately 10 and 400 nanometers, inclusive. Preferably, the emitted UV light has a wavelength between approximately 380 and 400 nanometers, inclusive. Light having any suitable wavelength can be used, such as, but not limited to, UV, visible and infrared light.

The liquid polymer resin 118 includes a photoinitiator that initiates photopolymerization in the tank 112 when the light emitted by the light source passes through the optically transparent window 126A of the base 126 of the tank 112. The photoinitiator absorbs light energy having a predetermined wavelength from the light emitted by the light source to the tank 112. The photoinitiator is preferably selected based on the wavelength of the light emitted by the light source.

As shown in FIG. 7, the printed object 122 is formed on the surface 120A of the rigid base 120. The printed object 122 is based on a model supplied to a computer (now shown) that controls the 3D printing process. The light emitted from the light source is guided to the tank to cure the liquid polymer resin 118 on the surface 120A of the rigid base 120 to form a first layer of the printed object 122. The control arm 124 is connected to the rigid base 120 to move the rigid base 120 relative to the tank 112 in a direction away from the optically transparent window 126A of the base 126. The rigid base 120 is moved a distance approximately equal to a thickness of the formed layer. The light is emitted from the light source to cure the liquid polymer resin 118 in the tank 112 to form a second layer on the first layer. This process is repeated until the entire object is printed. When the printing is complete, the printed object 122 can be removed from the print surface 120A of the rigid base 120.

As shown in FIG. 7, the textured substrate 114 is connected to the tank 112. The textured substrate 114 is preferably disposed on the optically transparent window 126A of the base 126. The textured substrate 114 is configured such that the light emitted by the light source passes through the textured substrate 114 to the liquid polymer resin 118 in the tank 112. The base 126 has an outer surface 126B that faces the light source and an inner surface 126C that faces the liquid polymer resin 118 and the print surface 120A of the rigid base 120. The textured substrate 114 is formed directly on an inner surface 152A of the optically transparent member 152 facing the liquid polymer resin 118.

The textured substrate 114 is disposed in the tank 112, as shown in FIG. 7. The textured substrate 114 is preferably disposed on the optically transparent window 126A of the base 126. The textured substrate 114 is disposed directly on the upper surface 152A of the optically transparent member 152. The textured substrate 114 is configured such that the light emitted by the light source passes through the textured substrate 114 to the liquid polymer resin 118 in the tank 112.

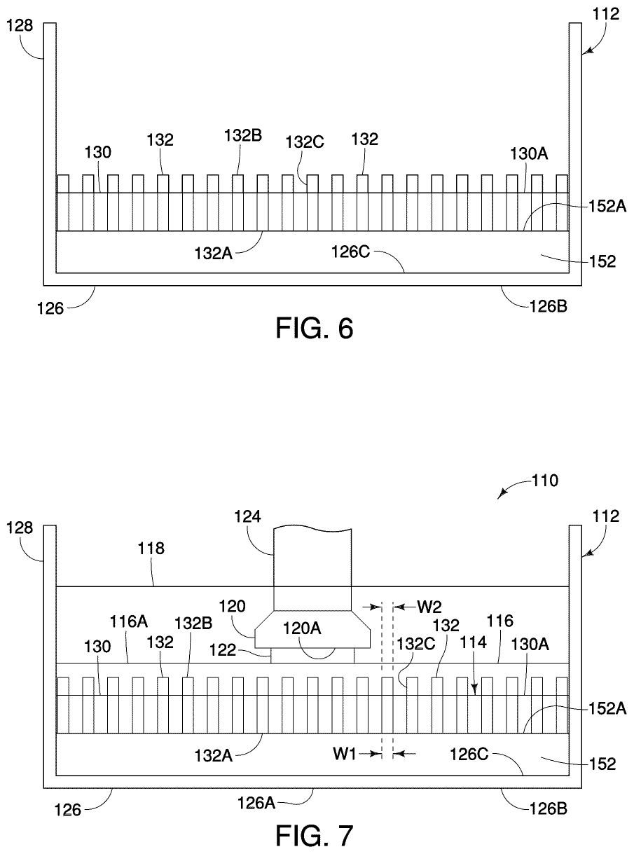

The textured substrate 114 is formed on the inner surface 126C of the base 126 of the tank 112, as shown in FIG. 7. The textured substrate 114 is formed directly on the upper surface 152A of the optically transparent member 152. Alternatively, the textured substrate 114 can be an insert disposed on the upper surface 152A of the optically transparent member 152. The textured substrate 114 includes a polymer layer 130 and a plurality of pillars 132 extending upwardly from an upper surface 130A of the polymer layer 130 to define a textured surface, as shown in FIGS. 6 and 7. The polymer layer 130 is disposed on the optically transparent window 126A. The polymer layer 130 is preferably disposed directly on the upper surface 152A of the optically transparent member 152. The polymer layer 130 is optically transparent such that light is configured to pass therethrough.

The textured substrate 114 is formed, as shown in FIG. 3-6. The plurality of pillars 132 are disposed on the inner surface 126C of the base 126 of the tank 112. The plurality of pillars 132 are disposed on the inner surface 126C in any suitable manner and configuration. The plurality of pillars 132 are disposed directly on the upper surface 152A of the optically transparent member 152. Each of the plurality of pillars 132 includes a magnetic material. The pillars 132 can be a magnetically impregnated material, such as polydimethylsiloxane (PDMS) or glass. In other words, the pillars 132 can be impregnated with nanoparticles of a magnetic material, such as ferric borate. The pillars 132 are optically transparent such that the emitted light passes therethrough. Each of the pillars 132 can be made of the same material or different materials. The magnet material can be the same in each pillar 132, can be different, and/or can be different amounts to control alignment of the pillars 132 when the magnetic field 138 is applied.

The pillars 132 can have any suitable shape and configuration. Each of the plurality of pillars 132 can be a solid cylinder. The pillars 132 being a solid cylinder increases rigidity of the pillars, such that turbulence is reduced during a printing operation. Alternatively, each of the plurality of pillars 132 can be a hollow tube. The pillars 132 being a hollow tube reduces a contact surface area at a second end 132B, such that a hydrophobic property of the pillars is increased. The pillars 132 preferably have a symmetric shape, such as a hollow tube or solid cylinder. Alternatively, as shown in FIG. 16, the pillars 632 can have a non-symmetric shape.

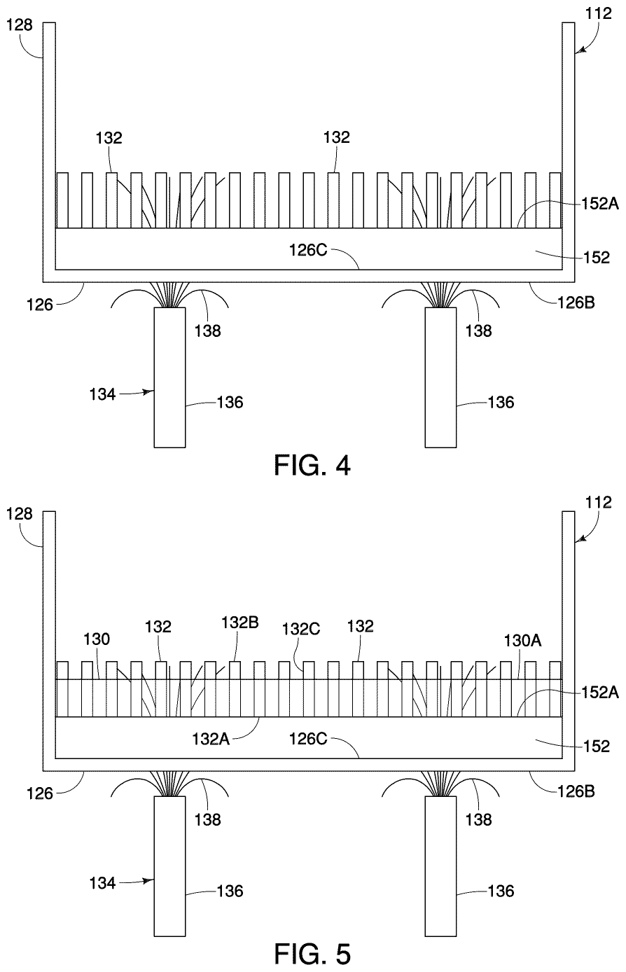

A magnetic array 134 includes a plurality of magnets 136, as shown in FIG. 4. Preferably, a plurality of magnets 136 are positioned adjacent the outer surface 126B of the tank 112. Alternatively, the magnetic array 134 can include two magnetic plates in which a first magnetic plate is disposed below the tank 112, and a second magnetic plate is disposed above the tank 112. Each of the first and second magnetic plates is larger than the area on which the pillars 132 are dispersed.

Each magnet 136 applies a magnetic field 138 to the pillars 130 disposed on the upper surface 152A of the optically transparent member 152. The applied magnetic fields 138 vertically align the pillars 132 and the magnetic material of each pillar 130 causes each pillar 132 to move to a substantially vertical position in which the pillars 132 are substantially evenly dispersed on the upper surface 152A of the optically transparent member 152. The number of magnets 136 and the strength of the applied magnetic field 138 controls the verticalness of the pillars 132 in the aligned position. Prior to applying the magnetic fields 138 with the magnetic array 134, the tank 112 can be vibrated, such as by an ultrasonic vibration, to more evenly disperse the pillars 132. Any suitable carbon nanotube alignment method can be used to align the pillars 132, such as, but not limited to, magneto-evaporation and anisotropic magnetic field alignment. The magnetic material of the pillars 132 allows for alignment of the pillars 132 using the magnetic fields 138.

A polymer, such as PDMS, is poured into the tank 112, as shown in FIG. 5, while the plurality of magnets 136 of the magnetic array 134 applies the magnetic fields 138 to the tank 112. In other words, the polymer is added to the tank 112 after aligning the plurality of pillars 132 while the magnetic fields 138 are still applied to the pillars 132. The polymer is added in a liquid form and allowed to harden. Preferably, the liquid polymer is added to a level below the second end 132B of each pillar 132. When the polymer has hardened, the magnetic array 134 is withdrawn from the tank 112, as shown in FIG. 6. The hardened polymer forms the polymer layer 130. A first end 132A of each pillar 132 is disposed in the polymer layer 130. The second end 132B of each pillar 132 is disposed above an upper surface 130A of the polymer layer 130. The hardened polymer layer 130 maintains the aligned position of the plurality of pillars 132 caused by the application of the magnetic fields 138.

The pillars 132 can have any suitable shape and configuration. As shown in FIG. 7, each of the pillars 132 is substantially similarly formed. Each of the pillars 132 has a similar substantially rectangular cross section. A first width W1 of the first end 132A of each pillar 132 is substantially equivalent to a second width W2 of the second end 132B of each pillar 132.

As shown in FIG. 7, the 3D printing system 110 includes the layer of the inert material 116 and the liquid photopolymer resin 118. The layer of the inert material 116 is disposed on the polymer layer 130. Preferably, an upper surface 116A of the layer of the inert material 116 is spaced above each of the second ends 132B of the pillars 132. In other words, the upper surface 116A of the layer of the inert material 116 is spaced above an uppermost surface 132B of each of the plurality of pillars 132. The liquid photopolymer resin 118 is disposed on the layer of the inert material 116.

An exposed portion 132C of each of the pillars 132 is the portion of the pillar 132 disposed above the upper surface 130A of the polymer layer 130, as shown in FIGS. 4 and 5. The exposed portion 132C of each of the plurality of pillars 132 above the upper surface 130A of the polymer layer 130 is substantially perpendicular to the upper surface 130A of the polymer layer 130. Preferably, each of the second ends 132B of the plurality of pillars 132 is disposed at the same distance from the upper surface 130A of the polymer layer 130, as shown in FIG. 6. In other words, each of the pillars 132 is substantially identical such that each of the second ends 132B is disposed at substantially the same height above the upper surface 130A of the polymer layer 130.

The plurality of pillars 132 preferably form a plurality of rows extending in a length direction of the base 126, and a plurality of columns extending in the width direction of the base 126, although the pillars can be arranged in any suitable configuration by controlling application of the magnetic fields 138. Each pillar 132 is preferably equally spaced from adjacent pillars 132 in the row by a predetermined distance. Each pillar 132 is preferably equally spaced from adjacent pillars 132 in the column by a predetermined distance. Preferably, the predetermined distances for the rows and columns of the protrusions 132 are substantially equal. The predetermined distances can be controlled by the application of the magnetic fields 138.

The pillars 132 increase the surface area of the textured substrate 114 to increase heat dissipation of the heat generated during light radiation and resin polymerization. In other words, the pillars 132 act like a heat sink to facilitate heat dissipation. Heat generated during the light radiation and resin polymerization during a printing process is dissipated from tank 112 through the textured substrate 114.

The layer of the inert material 116 is disposed on the polymer layer 130 of the textured substrate 114, as shown in FIG. 7. The liquid photopolymer resin 118 is disposed on the layer of the inert material 116. The layer of the inert material 116 facilitates preventing adhesion between the liquid polymer resin 118 and the textured substrate 114. The layer of the inert material 116 is preferably disposed above second ends 132B of the pillars 132 of the textured substrate 114, as shown in FIG. 7. A refractive index of the inert material 134 is approximately equal to a refractive index of the textured substrate 114. Substantially matching the refractive indices of the inert material 116 and the textured substrate 114 minimizes diffraction of the light emitted by the light source to facilitate maintaining printing resolution. The inert material 116 is preferably immiscible and non-reactive with the liquid polymer resin 118. Preferably, the inert material 116 has a higher density than the liquid polymer resin 118 to facilitate the inert material 116 being disposed between the textured substrate 114 and the liquid polymer resin 118. The inert material 116 can be any suitable liquid, such as perfluoropolyether copolymers, fluorosilicone polymers, perfluorocarbon liquid, allicin or garlic oils, Chemours Krytox GPL oil, and Solvay Fomblin Y oil. The inert material 116 preferably has a thickness of approximately 3 nm to approximately 5 nm, although the inert liquid 34 can have any suitable thickness.

The emitted light 20 (FIG. 1) passing through the layer of the inert material 116 exhibits minimal attenuation, such that the transmitted power of the emitted light is substantially not reduced. The resulting 3D printing process is energy efficient such that high-speed fabrication of parts is possible with the 3D printing process in accordance with the exemplary embodiments.

During a printing process, the light source emits light to the tank 112 to form the printed object 122 on the rigid base 120, as shown in FIG. 7. In a failed printing process, the printed object 122 can become adhered to the textured substrate 114 during the printing process. The pillars 132 of the textured substrate 114 can be damaged by removal of the printed object 122. A magnet 140 can be disposed adjacent the side wall 128 of the tank 112 to move the second end 132B of each of the plurality of pillars 132 disposed in the polymer layer 130. The magnet 140 applies a magnetic field 142 to the pillars 132 of the textured substrate 114 to move the second ends 132B of the pillars 132. A direction of the magnetic attraction 146 of the pillars 132 to the magnet 140 causes the second ends 132B of each of the pillars 132 to move toward the magnet 140. In other words, the exposed portions 132C are magnetically attracted to the magnet 140, and move the exposed portions 132C of the pillars 132 toward the magnet 140. The portion of the pillars 132 disposed in the polymer layer 130 is not moved by the magnetic field 142. The movement of the pillars 132 causes the inert material 116 to flow in a flow direction 144 toward the magnet 140. The flow of the inert material 116 causes the adhered printed object to detach from the pillars 132 without damaging the textured substrate 114.

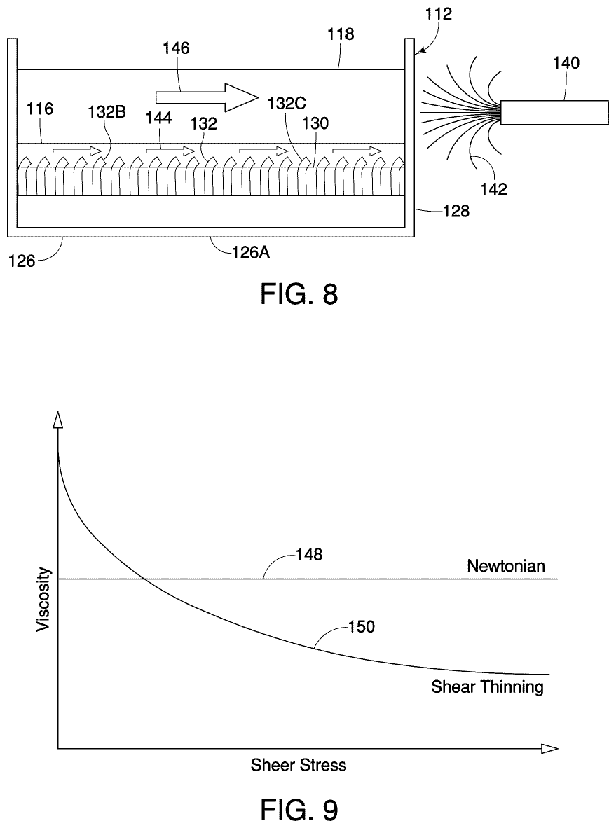

FIG. 9 is a graph of shear stress (horizontal axis) vs. viscosity (vertical axis). For certain fluids, such as water and alcohol, viscosity only depends on temperature. When the temperature does not change, the viscosity remains constant, as shown by line 148 in FIG. 9. For a non-newtonian fluid, such as the inert material 116, the viscosity depends on shear stress, as shown by the line 150 in FIG. 9. As shown by the line 150, the viscosity decreases as the shear stress increases. As shown in FIG. 8, applying the magnetic field 142 with the magnet 140 applies a deforming force to the pillars 132. The deforming force causes the viscosity of the inert material 116 to decrease and causes shear flow of the inert material 116. The shear flow of the inert material 116 results in shear thinning of the inert material 116, which increases the flow of the inert material 116. The faster moving insert material 116 relative to the liquid photopolymer resin 118 generates a shearing effect at the interface between the inert material 116 and the liquid polymer resin 118. The generated shearing effect substantially prevents adhesion of the liquid polymer resin 118 to the textured substrate 114. The magnet 140 of FIG. 8 can apply a magnetic field 142 to the pillars 132 during the printing process to induce shear thinning. A plurality of magnets 140 can apply magnetic fields to the pillars 132.

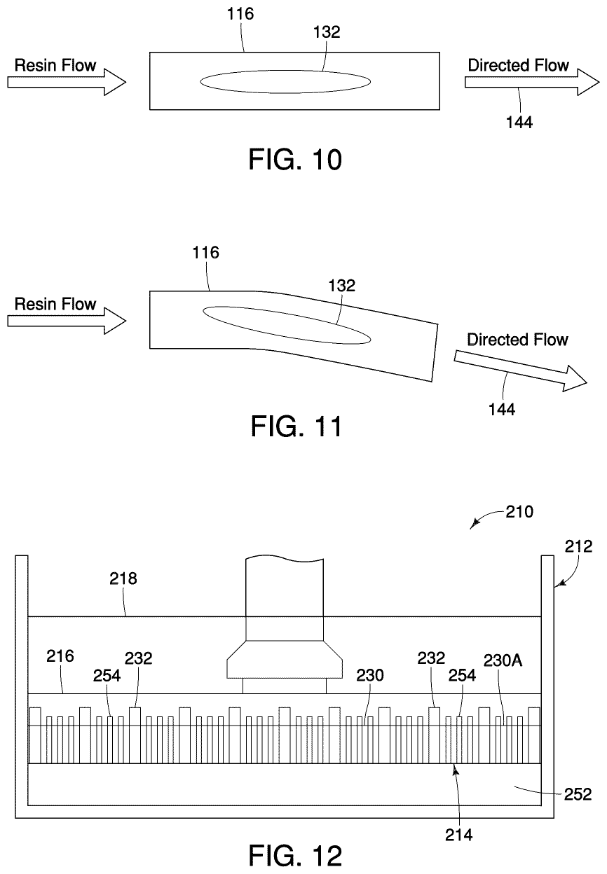

As shown in FIGS. 10 and 11, the deformation of the pillar 132 caused by the application of the magnetic field 142 (FIG. 8) can be used to control the flow 144 of the resin. As shown in FIG. 10, the flow 144 of the inert material 116 is in a first direction based on the non-deformation of the pillar 132. As shown in FIG. 11, the flow 144 of the inert material is in a second direction, which is different from the first direction (FIG. 10). Controlling the direction of the flow 144 of the inert material facilitates moving the inert material to a desired location, such as between the textured substrate 114 and the rigid base 120.

The method of making the textured substrate 114, as shown in FIG. 3-7, allows a textured substrate 114 to be made without the previous restrictions, such as size and shape limitations, as well as being brittle. The method of making the textured substrate 114, as shown in FIG. 3-7, can produce a larger textured substrate 114, such as larger than approximately 300 mm or 11.8 inches, that is configured to withstand deterioration associated with repeated printing operations. Additionally, the textured substrate 114 can be made to have any desired shape, such as circular and rectangular.

As shown in FIG. 12, a 3D printing system and method 210 in accordance with another illustrated exemplary embodiment is substantially similar to the 3D printing system and method 110 of the exemplary embodiment illustrated in FIG. 3-11 except for the differences described below. Similar parts are identified with similar reference numerals, except increased by 100 (i.e., 2xx, accordingly).

The 3D printing system 210 illustrated in FIG. 12 includes a textured substrate 214 disposed in a tank 212. A layer of the inert material 216 is disposed on the textured substrate 214. The liquid photopolymer resin 218 is disposed on the layer of the inert material 216.

The textured substrate 214 includes the polymer layer 230 and a plurality of pillars 232 extending upwardly from the upper surface 230A of the polymer layer 230, as shown in FIG. 12. A plurality of rigid projections 254 are disposed between adjacent pillars 232 of the plurality of pillars 232. The projections 254 do not include a magnetic material. The projections 254 can be fixed to the optically transparent member 252 prior to dispersing the pillars 232 thereon (FIG. 3). The projections 254 can extend above the upper surface 230A of the polymer layer 230. Alternatively, the projections 254 can be disposed entirely beneath the upper surface 230A of the polymer layer 230. The projections 254 provide rigidity to the textured substrate 214.

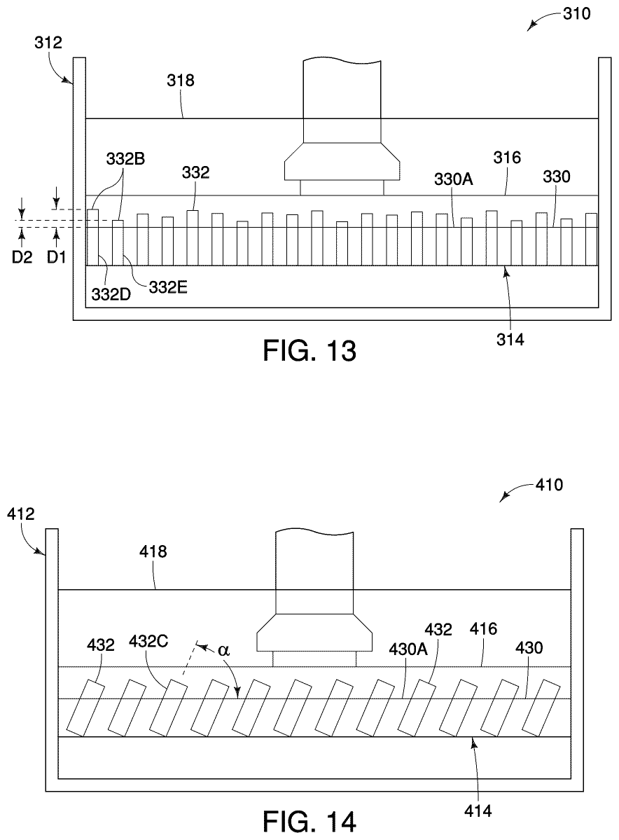

As shown in FIG. 13, a 3D printing system and method 310 in accordance with another illustrated exemplary embodiment is substantially similar to the 3D printing system and method 110 of the exemplary embodiment illustrated in FIG. 3-11 except for the differences described below. Similar parts are identified with similar reference numerals, except increased by 200 (i.e., 3xx, accordingly).

The 3D printing system 310 illustrated in FIG. 13 includes a textured substrate 314 disposed in a tank 312. A layer of the inert material 316 is disposed on the textured substrate 314. The liquid photopolymer resin 318 is disposed on the layer of the inert material 316.

The textured substrate 314 includes the polymer layer 330 and a plurality of pillars 332 extending upwardly from the upper surface 330A of the polymer layer 330, as shown in FIG. 13. The second ends 332B of the pillars 332 have varying heights above the upper surface 330A of the polymer layer 330. A second end 332B of a first pillar 332D is disposed a first distance D1 above the upper surface 330A of the polymer layer 330. The second end 332B of a second pillar 332E is disposed a second distance D2 above the upper surface 330A of the polymer layer 330. The second distance D2 is different from the first distance D1. As shown in FIG. 13, the second distance D2 is less than the first distance D1. Providing the pillars 332 with varying heights minimizes the upper surface of the pillars 332 that defines a contact surface with a printed object 122 (FIG. 7).

As shown in FIG. 14, a 3D printing system and method 410 in accordance with another illustrated exemplary embodiment is substantially similar to the 3D printing system and method 110 of the exemplary embodiment illustrated in FIG. 3-11 except for the differences described below. Similar parts are identified with similar reference numerals, except increased by 300 (i.e., 4xx, accordingly).

The 3D printing system 410 illustrated in FIG. 14 includes a textured substrate 414 disposed in a tank 412. A layer of the inert material 416 is disposed on the textured substrate 414. The liquid photopolymer resin 418 is disposed on the layer of the inert material 416.

The textured substrate 414 includes the polymer layer 430 and a plurality of pillars 432 extending upwardly from the upper surface 430A of the polymer layer 430, as shown in FIG. 14. The exposed portion 432C of each of the plurality of pillars 432 above the polymer layer 430 is angularly disposed relative to the upper surface 430A of the polymer layer 430. An angle α is defined between the exposed portion 432C of the pillar 432 and the upper surface 430A of the polymer layer 430. The angle α is any suitable angle less than ninety degrees, such as approximately sixty degrees. Each of the pillars 432 can have the same angle, or the magnetic field (138, FIG. 4) can be controlled to provide the pillars 432 with different angles and different angled directions, such as to the left or to the right in FIG. 14. Providing angled pillars 432 minimizes the upper surface of the pillars 332 that defines a contact surface with a printed object 122 (FIG. 7). The angled pillars 432 can also facilitate directing the flow of the inert material 416.

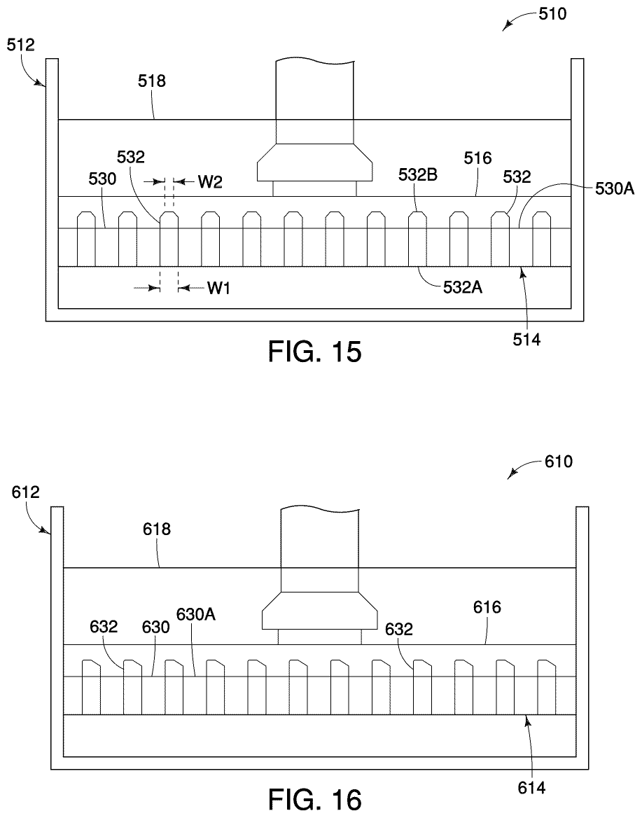

As shown in FIG. 15, a 3D printing system and method 510 in accordance with another illustrated exemplary embodiment is substantially similar to the 3D printing system and method 110 of the exemplary embodiment illustrated in FIG. 3-11 except for the differences described below. Similar parts are identified with similar reference numerals, except increased by 400 (i.e., 5xx, accordingly).

The 3D printing system 510 illustrated in FIG. 15 includes a textured substrate 514 disposed in a tank 512. A layer of the inert material 516 is disposed on the textured substrate 514. The liquid photopolymer resin 518 is disposed on the layer of the inert material 516.

The textured substrate 514 includes the polymer layer 530 and a plurality of pillars 532 extending upwardly from the upper surface 530A of the polymer layer 530, as shown in FIG. 15. Each of the plurality of pillars 532 has a first width W1 at the first end 532A and a second width W2 at a second end 532B. The first width W1 is different than the second width W2. As shown in FIG. 15, the first width W1 is larger than the second width W2 such that the upper surface of the pillars 532 that defines a contact surface with a printed object 122 (FIG. 7) is minimized. In other words, the second end 532B of the pillars 532 can be tapered to minimize the contact surface.

As shown in FIG. 16, a 3D printing system and method 610 in accordance with another illustrated exemplary embodiment is substantially similar to the 3D printing system and method 110 of the exemplary embodiment illustrated in FIG. 3-11 except for the differences described below. Similar parts are identified with similar reference numerals, except increased by 500 (i.e., 6xx, accordingly).

The 3D printing system 610 illustrated in FIG. 16 includes a textured substrate 614 disposed in a tank 612. A layer of the inert material 616 is disposed on the textured substrate 614. The liquid photopolymer resin 618 is disposed on the layer of the inert material 616.

The textured substrate 614 includes the polymer layer 630 and a plurality of pillars 632 extending upwardly from the upper surface 630A of the polymer layer 630, as shown in FIG. 16. Each of the plurality of pillars 632 is non-symmetric to facilitate directing the flow of the inert material 616 during a printing process. The pillars 632 can have any suitable non-symmetric shape.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A 3D printing system comprising:
a tank including an optically transparent window through which light is configured to pass;
a polymer layer disposed on the optically transparent window, the polymer layer being optically transparent such that light is configured to pass therethrough;
a plurality of pillars extending upwardly from an upper surface of the polymer layer to define a textured substrate, each of the plurality of pillars including a magnetic material;
a layer of an inert material disposed on the polymer layer; and
a liquid photopolymer resin disposed on the layer of the inert material.

2. The 3D printing system according to claim 1, wherein
an upper surface of the inert material is spaced above an uppermost surface of each of the plurality of pillars.

3. The 3D printing system according to claim 1, wherein
a first end of each of the plurality of pillars is disposed in the polymer layer, and a second end of each of the plurality of pillars is disposed above the polymer layer.

4. The 3D printing system according to claim 3, wherein
an exposed portion of each of the plurality of pillars above the polymer layer is substantially perpendicular to the upper surface of the polymer layer.

5. The 3D printing system according to claim 3, wherein
an exposed portion of each of the plurality of pillars above the polymer layer is angularly disposed relative to the upper surface of the polymer layer.

6. The 3D printing system according to claim 3, wherein
the second each of each of the plurality of pillars is disposed at the same distance from the upper surface of the polymer layer.

7. The 3D printing system according to claim 3, wherein
the second end of a first pillar is disposed a first distance above the upper surface of the polymer layer, and the second end of a second pillar is disposed a second distance above the upper surface of the polymer layer, the second distance being different from the first distance.

8. The 3D printing system according to claim 1, wherein each of the plurality of pillars is a hollow tube.

9. The 3D printing system according to claim 1, wherein each of the plurality of pillars is a solid cylinder.

10. The 3D printing system according to claim 1, wherein at least one of the plurality of pillars has a non-symmetric cross section.

11. The 3D printing system according to claim 1, wherein
a magnet moves a second end of each of the plurality of pillars disposed in the polymer layer.

12. The 3D printing system according to claim 3, wherein
each of the plurality of pillars has a first width at the second end and a second width at the upper surface of the polymer layer, the first width being substantially equivalent to the second width.

13. The 3D printing system according to claim 3, wherein
each of the plurality of pillars has a first width at the first end and a second width at the second end, the first width being different from the second width.

14. The 3D printing system according to claim 3, wherein
a plurality of rigid projections are disposed between adjacent pillars of the plurality of pillars.

15. A 3D printing system comprising:
a tank including an optically transparent window through which light is configured to pass;
a polymer layer disposed on the optically transparent window, the polymer layer being optically transparent such that light is configured to pass therethrough;
a plurality of pillars extending upwardly from an upper surface of the polymer layer to define a textured substrate, each of the plurality of pillars including a magnetic material;
a layer of an inert material disposed on the polymer layer; and
a liquid photopolymer resin disposed on the layer of the inert material,
a first end of each of the plurality of pillars is disposed in the polymer layer, and a second end of each of the plurality of pillars is disposed above the polymer layer, and
an upper surface of the inert material being spaced above the second end of each of the plurality of pillars.

16. The 3D printing system according to claim 15, wherein
an exposed portion of each of the plurality of pillars above the polymer layer is substantially perpendicular to the upper surface of the polymer layer.

17. The 3D printing system according to claim 15, wherein
an exposed portion of each of the plurality of pillars above the polymer layer is angularly disposed relative to the upper surface of the polymer layer.

18. The 3D printing system according to claim 15, wherein
the second each of each of the plurality of pillars is disposed at the same distance from the upper surface of the polymer layer.

19. The 3D printing system according to claim 15, wherein
the second end of a first pillar is disposed a first distance above the upper surface of the polymer layer, and the second end of a second pillar is disposed a second distance above the upper surface of the polymer layer, the second distance being different from the first distance.

20. The 3D printing system according to claim 15, wherein
a magnet moves a second end of each of the plurality of pillars disposed in the polymer layer.
